(19) United States
(12) Patent Application Publication
(10) Pub. No.: US 2020/0408973 A1
(43) Pub. Date: Dec. 31, 2020

(54) UTILIZING A FRESNEL ZONE PLATE LENS TO AMPLIFY A MICROWAVE SIGNAL ATTENUATED BY A MICROWAVE-REFLECTING WINDOW

(71) Applicant: CORNING INCORPORATED, CORNING, NY (US)

(72) Inventors: Nicholas Francis Borrelli, Elmira, NY (US); Wageesha Senaratne, Horseheads, NY (US); Sergey Yurevich Ten, Corning, NY (US)

(21) Appl. No.: 16/976,177

(22) PCT Filed: Mar. 5, 2019
(86) PCT No.: PCT/US2019/020796

§ 371 Date: Aug. 27, 2020

Related U.S. Application Data
(60) Provisional application No. 62/639,159, filed on Mar. 6, 2018.
(60) Provisional application No. 62/643,439, filed on Mar. 15, 2018.

(51) Int. Cl. G02B 5/18; H01Q 19/06; C03C 17/36

(52) U.S. Cl. CPC G02B 5/1885; H01Q 19/065; C03C 2218/34; C03C 2218/33; C03C 17/366

(57) ABSTRACT

A system includes a window and a microwave amplifier positioned proximate the window. The window has a low-E coating. The microwave amplifier includes a substrate and multiple concentric rings of material that form a Fresnel zone plate lens. The concentric rings are attached to the substrate. The Fresnel zone plate lens is configured to focus an attenuated microwave signal, which is attenuated by the low-E coating of the window, on an antenna, which may (1) amplify the attenuated microwave signal by at least 20 dB and/or (2) provide an image at the antenna such that an area of the Fresnel zone plate lens divided by an area of the image is at least 100 and/or such that the area of the image is approximately equal to an area of the antenna. The attenuated microwave signal has a designated frequency in a range of frequencies from 6 GHz to 80 GHz.

### CROSS-REFERENCE TO RELATED APPLICATIONS

This application claims the benefit of priority under 35 U.S.C. § 119 of U.S. Provisional Application No. 62/639,159, filed Mar. 6, 2018, and Provisional Application No. 62/643,439, filed Mar. 15, 2018, the content of each of which is incorporated herein by reference in their entirety.

### BACKGROUND

Recent innovations in window design have led to windows having greater energy efficiency. A window may have a single sheet (e.g., pane) of glass or multiple sheets of glass. Each sheet may include a single layer of glass or multiple layers of glass that are attached using an adhesive. The energy efficiency of modern windows often is increased by covering a surface of at least one of the sheets with a low thermal emissivity coating (a.k.a. low-E coating) and/or by filling a space between the sheets with an inert gas having relatively low thermal conductivity. Each low-E coating manages electromagnetic (EM) radiation that is incident on the coating.

Low-E coatings often are metallic. For instance, silver is commonly used as a low-E coating. Accordingly, low-E coatings typically reflect frequencies that are used in cellular communications in addition to infrared frequencies that are intended to be blocked for greater energy efficiency. A low-E coating may attenuate radio waves having a frequency of greater than 1.0 GHz up to 40 dB. Building materials typically allow frequencies in the range of 0.6 gigahertz (GHz) to 2.7 GHz, which are used by 3G and 4G cellular systems, to pass through with relatively low attenuation. Thus, attenuation of 3G and 4G frequencies by low-E coatings in windows traditionally has not been a significant issue. However, the same building materials typically attenuate frequencies in the range of 6 GHz to 100 GHz, which are used by 5G systems, quite substantially (e.g., nearly 100% in some instances). Accordingly, 5G systems often require line of sight (LOS) to a receiver due to relatively low penetration through walls, foliage, etc.

It was initially believed that windows would be sufficiently transparent to frequencies in the 5G spectrum that customer premise equipment (CPE) could be placed near the interior surface of the windows to enable the CPE to communicate via such frequencies. However, the realization that windows often are coated with a metallic layer may lead to higher cost solutions, such as placing an external antenna outside a structure in which the CPE is located. However, if an antenna is placed outside, a coaxial cable is likely to be used for routing signals in and out of the structure (e.g., between the CPE and the antenna). Coaxial cable is known to have relatively high losses at carrier frequencies within the 5G spectrum. Thus, an outside unit is likely to include the antenna and a receiver to convert centimeter-wave and millimeter-wave signals into baseband signals and to transmit them through an interconnect that may carry up to several gigabits-per-second (Gb/s) data rates. Placing such a unit outside may cause challenges with cable routing and bringing the cable inside the structure.

### SUMMARY

Various systems are described herein that are configured to utilize a Fresnel zone plate lens (FZPL) to amplify a microwave signal that has been attenuated by a microwave-reflecting window. A FZPL includes multiple concentric rings having spacings therebetween. For example, each pair of adjacent rings of the FZPL may be separated by a respective ring-shaped space. The concentric rings and the spaces therebetween may be circular. For instance, radially symmetric rings may be separated by radially symmetric spaces. The rings of the FZPL may be substantially opaque with regard to microwave frequencies. The spaces between the rings may be substantially transparent with regard to microwave frequencies.

The microwave signal may diffract around the concentric rings of the FZPL and become focused (i.e., amplified) at a focal plane where an antenna may receive the amplified microwave signal. For example, the spacings between the concentric rings may be set to cause the diffracted microwave signal to constructively interfere at the focal plane. In accordance with this example, the focal length of the FZPL may depend on the spacings between the concentric rings.

A first example system includes a window and a microwave amplifier. The window has a low thermal emissivity coating. The low thermal emissivity coating has a reflectivity of at least 90% with regard to microwave frequencies. The microwave amplifier is positioned proximate the window. The microwave amplifier includes a substrate and multiple concentric rings of material that form a FZPL. The FZPL is configured to focus an attenuated microwave signal, which is attenuated by the low thermal emissivity coating of the window, on an antenna to amplify the attenuated microwave signal by at least 20 dB. The attenuated microwave signal has a designated frequency in a range of frequencies from 6 GHz to 80 GHz. The concentric rings are attached to the substrate.

A second example system includes a window and a microwave amplifier. The window has a low thermal emissivity coating. The low thermal emissivity coating has a reflectivity of at least 90% with regard to microwave frequencies. The microwave amplifier is positioned proximate the window. The microwave amplifier includes a substrate and multiple concentric rings of a material that form a FZPL. The concentric rings are attached to the substrate. The FZPL is configured to focus an attenuated microwave signal, which is attenuated by the low thermal emissivity coating of the window and which has a designated frequency in a range of frequencies from 6 GHz to 80 GHz, on an antenna to provide an image at the antenna such that an area of the FZPL divided by an area of the image is at least 100 and such that the area of the image is approximately equal to an area of the antenna.

In an example method of amplifying a microwave signal that passes through a window, the microwave signal is received at the window. The microwave signal has at least one frequency in a range of frequencies from 6 GHz to 80 GHz. The microwave signal is attenuated as the microwave signal passes through the window, including a low thermal emissivity coating of the window that has a reflectivity of at least 90% with regard to microwave frequencies, to provide an attenuated microwave signal. The attenuated microwave signal is focused on an antenna, using a FZPL that is formed by a plurality of concentric rings of material that are attached to a substrate, to amplify the attenuated microwave signal by at least 20 dB.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example system that utilizes a Fresnel zone plate lens to amplify a microwave signal that has been attenuated by a microwave-reflecting window in accordance with an embodiment.

FIG. 2 is an example plot of loss tangent with respect to frequency for EXG™ glass and HPFS™ glass in accordance with an embodiment.

FIGS. 3A-3C show example Fresnel zone plate lenses in accordance with embodiments.

FIG. 4 shows a cross-section of an example system in which a Fresnel zone plate lens focuses an attenuated microwave signal on an antenna in accordance with an embodiment.

FIG. 5 is an example intensity profile for an image that is produced at a focal plane by a Fresnel zone plate lens in accordance with an embodiment.

FIG. 6 shows a cross-section of an example system in which a microwave amplifier is adhered to a double-pane window in accordance with an embodiment.

FIG. 7 shows a cross-section of an example system in which a microwave amplifier is adhered to a triple-pane window in accordance with an embodiment.

FIG. 8 depicts a flowchart of an example method for amplifying a microwave signal that passes through a window in accordance with an embodiment.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### II. Example Embodiments

Example systems described herein are configured to utilize a Fresnel zone plate lens (FZPL) to amplify a microwave signal that has been attenuated by a microwave-reflecting window. A FZPL includes multiple concentric rings having spacings therebetween. For example, each pair of adjacent rings of the FZPL may be separated by a respective ring-shaped space. The concentric rings and the spaces therebetween may be circular. For instance, radially symmetric rings may be separated by radially symmetric spaces. The rings of the FZPL may be substantially opaque with regard to microwave frequencies. The spaces between the rings may be substantially transparent with regard to microwave frequencies.

The microwave signal may diffract around the concentric rings of the FZPL and become focused (i.e., amplified) at a focal plane where an antenna may receive the amplified microwave signal. For example, the spacings between the concentric rings may be set to cause the diffracted microwave signal to constructively interfere at the focal plane. In accordance with this example, the focal length of the FZPL may depend on the spacings between the concentric rings.

Example systems described herein have a variety of benefits as compared to conventional window systems. For instance, the example systems may provide a relatively high energy efficiency (e.g., by attenuating infrared frequencies) while amplifying one or more microwaves frequencies (e.g., 5G frequencies) that are attenuated by a window. For example, a microwave amplifier that includes a FZPL may be utilized with a conventional window (e.g., a standard double-pane or triple-pane window) to amplify the one or more microwave frequencies. Such amplification may occur while maintaining the full required infrared reflectivity. The microwave amplifier, including the substrate and the concentric rings of material that form the FZPL, may have a thickness that is less than or equal to one millimeter (mm), 200 micrometers (μm), 150 μm, or 100 μm. The microwave amplifier may be substantially flat. For instance, surfaces of the concentric rings and the substrate through which microwave frequencies pass may be substantially flat. The substrate may be highly transparent to one or more microwave frequencies (e.g., 28 GHz, 37 GHz, 39 GHz, and/or 60 GHz). A process that is utilized to form the microwave amplifier may be capable of creating the FZPL to be approximately the size of the window with which the microwave amplifier is to be used. Application of the microwave amplifiers described herein to existing window structures may be relatively straightforward. An antenna may be easily aligned to the focal plane of the FZPL to achieve a desired amplification of the microwave signal. More complex diffractive elements may be used in conjunction with the FZPL to provide additional functions. The example systems may substantially increase a signal-noise-ratio of microwave signals that pass through the window.

One type of glass that may be used in the systems described herein is Eagle XG (EXG™) glass, which is made and distributed by Corning Inc. EXG™ glass is referenced throughout this document for illustrative purposes and is not intended to be limiting. For instance, the performance of EXG™ may be contrasted with the performance of soda-lime glass (SLG) for non-limiting, illustrative purposes merely to show performance improvements that may be achieved using glass materials that differ from SLG. It will be recognized that any suitable type of glass may be used in combination with or in lieu of EXG™ glass in any of the systems described herein. Moreover, any of the glass layers described herein may be fabricated to have any one or more of the properties associated with EXG™ glass or none of the properties associated with EXG™ glass.

The substrate of the microwave amplifiers described herein may exhibit a relatively low inherent loss for centimeter waves and/or millimeter waves. For example, the substrate may be a glass material such as EXG™ glass, which may have a dielectric loss tangent that is approximately nine or ten times lower than the loss tangent of SLG (e.g., at 28 GHz, 37 GHz, 39 GHz, and/or 60 GHz). In another example, the loss tangent of the substrate may be less than or equal to 0.01, 0.008, or 0.006 for a targeted frequency or a range of targeted frequencies.

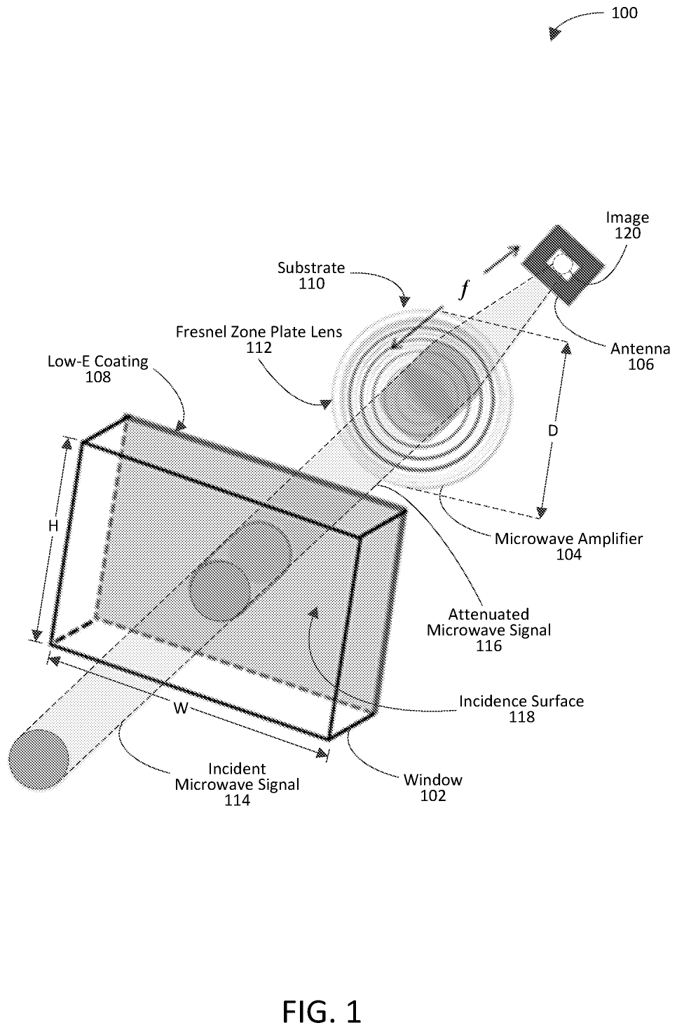

FIG. 1 is a block diagram of an example system 100 that utilizes a Fresnel zone plate lens (FZPL) 112 to amplify a microwave signal 116 that has been attenuated by a microwave-reflecting window 102 in accordance with an embodiment. As shown in FIG. 1, the system 100 includes the window 102, a microwave amplifier 104, and an antenna 106. The window has a low-E coating 108 that reflects microwave frequencies. For example, the low-E coating 108 may have a reflectivity with regard to microwave frequencies that is greater than or equal to a threshold reflectivity. In accordance with this example, the threshold reflectivity may be 85%, 90%, or 95%. The low-E coating 108 may include a single coating or multiple coatings. If the low-E coating 108 includes multiple coatings, an average of the reflectivities of the respective coatings with regard to microwave frequencies may be greater than or equal to the threshold reflectivity, and/or each of the reflectivities of the respective coatings may be greater than or equal to the threshold reflectivity.

The low-E coating 108 may attenuate an incident microwave signal 114, which is incident on the window 102 (e.g., at incidence surface 118), to provide the attenuated microwave signal 116. The incident microwave signal 114 (and therefore the attenuated microwave signal 116) has a designated frequency in a specified range of frequencies. For instance, the specified range of frequencies may be from 6 GHz to 80 GHz, from 20 GHz to 80 GHz, from 28 GHz to 80 GHz, or from 28 GHz to 60 GHz. The designated frequency may be 28 GHz, 37 GHz, 39 GHz, or 60 GHz.

The microwave amplifier 104 is positioned proximate the window 102. For example, the microwave amplifier 104 may be in physical contact with the window 102 (e.g., attached to a surface of the window 102). In accordance with this example, the microwave amplifier 104 may be adhered to a surface of the window 102 that is configured to face an interior of an object on which the window 102 is to be installed or a surface of the window 102 that is configured to face an exterior of the object. Examples of an object on which the window 102 may be installed include but are not limited to a commercial building, a residential building, a train, a car, a coach, a boat, a truck, an industrial vehicle, an airplane, a helicopter, and a ski lift. In accordance with this example, the orientation of the microwave amplifier 104 may be dependent on the orientation of the window 102.

In another example, the microwave amplifier 104 may be separated from the window 102 by a spaced distance. In accordance with this example, the spaced distance may be at least one centimeter (cm), at least 2 cm, or at least 5 cm. In one aspect of this example, the orientation of the microwave amplifier 104 is independent from the orientation of the window 102. In another aspect of this example, the orientation of the microwave amplifier 104 is dependent on the orientation of the window 102. For instance, in an example embodiment, an angle of incidence of the incident microwave signal 114 at the incidence surface 118 of the window 102 is greater than zero. The angle of incidence is measured with respect to an axis that is normal to the incidence surface 118. In accordance with this embodiment, the microwave amplifier 104 is oriented such that an angle between the incidence surface 118 and a surface of the substrate 110 upon which the attenuated microwave signal 116 is incident is approximately equal to the angle of incidence of the incident microwave signal 114 at the incidence surface 118.

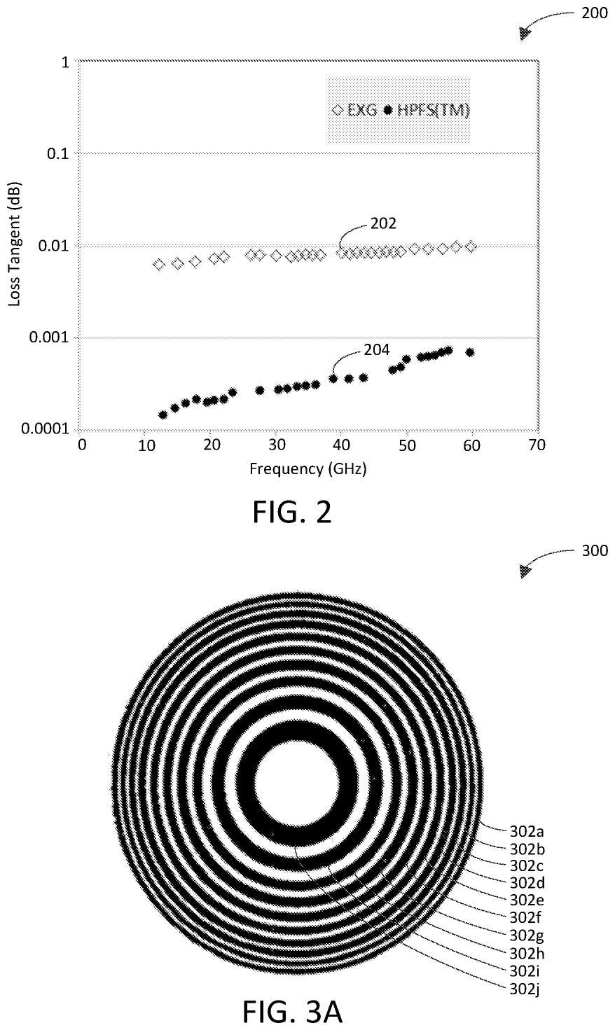

The microwave amplifier 104 includes a substrate 110 and the FZPL 112. The substrate 110 may be any suitable material including but not limited to glass (e.g., ultrathin and/or flexible glass) and/or a polymer. The substrate 110 may have a dielectric loss tangent that is less than or equal to a threshold value. For instance, the threshold value may be 0.01, 0.008, or 0.006 (e.g., at the designated frequency of the attenuated microwave signal 116). The substrate 110 may have a thickness that is less than or equal to a threshold thickness. For instance, the threshold thickness may be 2.0 mm, 1.5 mm, 1.0 mm, 500 μm, 200 μm, 150 μm, or 100 μm. In some example embodiments, the substrate 100 is EXG™ glass. Some advantages of EXG™ glass are described below with reference to FIG. 2.

The FZPL 112 may be formed by concentric rings of a material on the substrate 110. For instance, the concentric rings of the material may be attached to (e.g., deposited on or adhered to) the substrate 110 to form the FZPL 112 thereon. The concentric rings of the FZPL 112 may be formed such that the concentric rings are visually undetectable by a human eye having 20/20 vision beyond a specified distance. For instance, the concentric rings may not be detectable by a human eye having 20/20 vision at (or beyond) a distance of one meter (m), 2 m, 5 m, or 10 m. The material from which the FZPL 112 is formed may be any suitable type of material. For example, the material may be a microwave-reflective material. It will be recognized that although the material may be microwave-reflective, the FZPL 112 as a whole may be microwave-transmissive. For instance, the spaces between the concentric rings of the FZPL 112 may allow microwave frequencies to pass through. In one aspect of this example, the material may be a low-E coating. For instance, a composition of the low-E coating 108 of the window 102 and a composition of the material from which the FZPL 112 is formed may be essentially the same. In another aspect of this example, the material may be metallic (e.g., include one or more metals). In another example, the material may be a polymer.

In one example implementation, the concentric rings of the FZPL 112 are formed by screen printing portions of the material that correspond to the respective concentric rings on the substrate 110. A series of example process steps for forming the concentric rings using a screen printing technique will now be described. In a first step, a 24″×24″ sheet of EXG™ glass having a thickness in a range of 0.3-0.5 mm is washed using a standard glass cleaning procedure and then stored. In a second step, three main tasks are performed. In a first task, a microwave-opaque ink that is configured to absorb and/or reflect microwave frequencies (e.g., silver-based ink) is identified for screen printing, and an emulsion thickness is chosen. In a second task, a screen having appropriate mesh size, percent opening, and print features (e.g., pattern corresponding to the concentric rings of the FZPL 112) is selected. In a third task, the surface of the screen is flooded with the ink, and when the surface of the screen is sufficiently wetted with the ink, the surface of the screen is pressed against a surface of the EXG™ glass using varying print speed (mm/sec), gap (mm), and print pressure (KgF or psi). The first and third tasks control the thickness of the printed ink. In a third step, a post-ultraviolet (post-UV) or bake step is applied directly to the printed surface.

In another example implementation, the material includes a first portion that corresponds to the concentric rings of the FZPL 112 and a second portion that does not correspond to the concentric rings. In accordance with this implementation, the concentric rings are formed by covering the substrate 110 with the material and etching the second portion of the material from the substrate 110. A series of example process steps for forming the concentric rings using an etching technique will now be described. First and second steps of the technique are the same as those described above with regard to the screen printing technique, except that an etch-resistant ink is identified and used (rather than a microwave-opaque ink). In a third step, thermal or UV curing is performed to bake the etch-resistant ink. In a fourth step, acid etching is performed using bath or spray etching to etch structures into the glass, and the ink is removed using a cleaning technique. This process can be performed on a low-E coated surface and then specified regions may be etched from the masking process to create the FZPL 112.

In yet another example implementation, the concentric rings of the FZPL 112 are formed by spray coating (or sputter coating) the material onto the substrate 110 through holes in a mask that correspond to the concentric rings. A series of example process steps for forming the concentric rings using a spray coating technique (or a sputter coating technique) will now be described. The first step of the technique is the same as the one described above with regard to the screen printing technique. In a second step, three main tasks are performed. In a first task, a mask designed with the specification of the FZPL 112 is created. For instance, holes in the mask correspond to the concentric rings of the FZPL 112. In a second task, the mask is placed (e.g., adhered) onto the 24″×24″ sheet of EXG™ glass having the thickness in the range of 0.3-0.5 mm. In a third task, an identified microwave-opaque material is spray coated (or sputter coated) onto the sheet of EXG™ glass through the holes in the mask. In a third step, a post-UV or bake step is applied directly to the spray-printed surface (or sputter-printed surface) to adhere the concentric rings of the FZPL 112 onto the sheet of EXG™ glass. Spray coating and sputter coating techniques are described above for illustrative purposes and are not intended to be limiting. It will be recognized that the material may be coated onto the substrate 110 using any suitable deposition technique.

The FZPL 112 is configured to focus the attenuated microwave signal 116, which has been attenuated by the low-E coating 108 of the window 102, on the antenna 106. In an example implementation, the FZPL 112 focusing the attenuated microwave signal 116 on the antenna 106 amplifies the attenuated microwave signal 116 by at least a threshold amount (e.g., by at least 20 dB, 30 dB, or 40 dB). In accordance with this implementation, the low-E coating 108 of the window 102 may be configured to attenuate the incident microwave signal 114 by at least the threshold amount to provide the attenuated microwave signal 116, and the FZPL 112 may be configured to compensate for the low-E coating 108 attenuating the incident microwave signal 114 by the threshold amount by focusing the attenuated microwave signal 116 on the antenna 106 to amplify the attenuated microwave signal 116 by at least the threshold amount.

In another example implementation, the FZPL 112 focusing the attenuated microwave signal 116 on the antenna 106 provides an image 120 at the antenna 106 such that an area of the FZPL 112 divided by an area of the image 120 is at least one-hundred and/or such that the area of the image 120 is approximately equal to an area of the antenna 106.

The diameter D of the FZPL 112 may be selected to be approximately the same as the width W and/or the height H of the window 102. For instance, selecting the diameter D of the FZPL 112 in this manner may serve to increase the achievable gain when the FZPL 112 focuses the attenuated microwave signal 116 on the antenna 106. In one example implementation, the diameter D of the FZPL 112 is in a range from 40 cm to 80 cm. For instance, the diameter D may be in a range from 40 cm to 60 cm or from 60 cm to 80 cm.

The antenna 106 is positioned a spaced distance n from the microwave amplifier 104 or from the FZPL 112 therein. In an example implementation, the distance n is selected to correspond to (e.g., to be equal to or approximately equal to) a focal length of the FZPL 112. In accordance with this implementation, the focal length of the FZPL 112 is based on spacings between the concentric rings of the FZPL 112. For example, the focal length of the FZPL 112 may be in a range from 20 cm to 40 cm. In another example, the focal length of the FZPL 112 may be in a range from 40 cm to 60 cm.

It will be recognized that the system 100 shown in FIG. 1 may not include one or more of the components shown therein. For instance, the system 100 need not necessarily include the antenna 106. Furthermore, the system 100 may include components in addition to or in lieu of the components shown therein. For instance, the system 100 may include one or more other diffractive elements, which may be used in conjunction with the FZPL 112 to provide additional functions.

FIG. 2 is an example plot 200 of loss tangent with respect to frequency for EXG™ glass and High Purity Fused Silicon™ (HPFS™) glass, which is made and distributed by Corning Inc., in accordance with an embodiment. In particular, curve 202 corresponds to a sheet of EXG™ glass, and curve 204 corresponds to a sheet of HPFS™ glass. As shown in FIG. 2, the loss tangent of EXG™ glass is approximately ten times the loss tangent of HPFS™ glass; whereas, the loss tangent of other types of glass often is much greater than ten times the loss tangent of HPFS™ glass. For instance, the loss tangent of soda-lime glass (SLG) is approximately 100 times the loss tangent of HPFS™ glass. Accordingly, EXG™ glass may serve as a suitable substrate on which to form a FZPL to facilitate reception of microwave frequencies through a microwave-reflecting window.

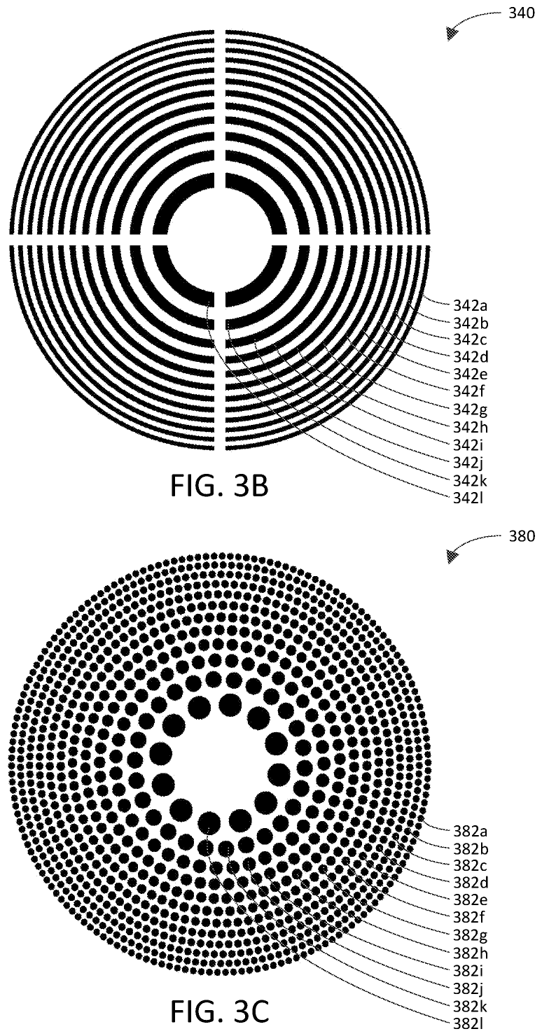

FIGS. 3A-3C show example Fresnel zone plate lenses (FZPLs) 300, 340, 380 in accordance with embodiments. As shown in FIG. 3A, the FZPL 300 includes multiple concentric rings 302a-302j, which are represented by dark circles. The concentric rings 302a-302j may be substantially opaque to a microwave signal having a designated wavelength λ. For instance, the concentric rings 302a-302j may be substantially opaque to a range of wavelengths that includes the designated wavelength λ. Adjacent concentric rings are separated by a spaced distance. The spaces between the concentric rings 302a-302j are represented by light circles. The microwave signal having the designated wavelength λ may pass through the spaces between the concentric rings 302a-302j. For instance, the microwave signal may diffract around the concentric rings 302a-302j and pass through the spaces.

The FZPL 300 may be defined by the following ring radii formula:

$${r}_{n} = \sqrt{n λ f + {( \frac{n λ}{2} )}^{2}} ≃ \sqrt{n λ f} \qquad ( Equation 1 )$$

where rₙ is the radius of the n^{th} ring, f is the focal length of the FZPL 300, n is the ring number, and λ is the designated wavelength. The intensity I_{B} at the focal plane that is produced by the FZPL 300 is given by the following equation when W=π:

$${I}_{B} = \frac{constrant ( 1 - cos 2 NW )}{{W}^{2} ( 1 + cos W )} \qquad ( Equation 2 )$$

Each of the concentric rings 302a-302j is shown in FIG. 3A to be continuous for non-limiting, illustrative purposes. For instance, each of the concentric rings 302a-302j includes no gaps. It will be recognized that any one or more of the rings 302a-302j may be non-continuous. For example, as shown in FIG. 3B, the FZPL 340 includes multiple non-continuous concentric rings 342a-342l, each of which is represented by disconnected dark circle segments. The circle segments in each non-continuous concentric ring are separate by gaps. Each of the gaps is a spaced distance. Each of the non-continuous concentric rings 342a-342l includes four ring segments for non-limiting, illustrative purposes. It will be recognized that each non-continuous concentric ring may include any suitable number of ring segments, and such ring segments may or may not be symmetrical. The number of ring segments in any one or more of the non-continuous concentric rings 342a-342l may the same as or different from the number of ring segments in any one or more of the other non-continuous concentric rings. As shown in FIG. 3C, the FZPL 380 includes multiple non-continuous concentric rings 382a-382l, each of which is represented by multiple dark dots arranged along a respective concentric circle. Each of the non-continuous concentric rings 382a-382l may include any suitable number of dots.

The FZPL 300 is shown in FIG. 3A to have ten concentric rings for non-limiting, illustrative purposes. The FZPLs 340 and 380 are shown in FIGS. 3B-3C to have twelve concentric rings for non-limiting, illustrative purposes. It will be recognized that each of the FZPLs described herein, including the FZPLs 300, 340, and 380, may have any suitable number of concentric rings. The ring segments shown in FIG. 3B and the dots shown in FIG. 3C may be any suitable shape. It will be recognized that the ring segments shown in FIG. 3B and the dots shown in FIG. 3C need not necessarily be separated by gaps. For instance, the ring segments (or subset(s) thereof) and/or the dots (or subset(s) thereof) may be in physical contact with each other.

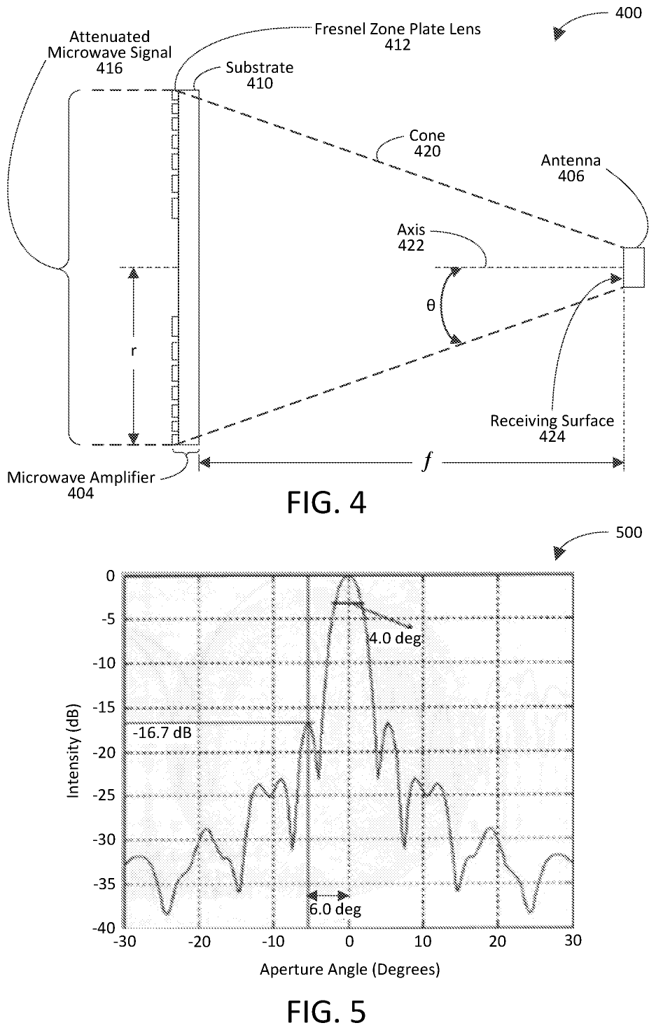

FIG. 4 shows a cross-section of an example system 400 in which a Fresnel zone plate lens (FZPL) 412 focuses an attenuated microwave signal 416 on an antenna 406 in accordance with an embodiment. As shown in FIG. 4, the system 400 includes a microwave amplifier 404 and the antenna 406. The microwave amplifier 404 includes the FZPL 412 and a substrate 410. A radius of the FZPL 412 is represented as r. A focal length of the FZPL is represented as f. Spacings between the concentric rings of the FZPL 412 may be selected (e.g., calibrated) to set the focal length f to a desired distance. For instance, the spacings may be selected to cause a focal plane that is produced by the FZPL 412 to coincide with a receiving surface 424 of the antenna 406. The ratio of the diameter of the FZPL 412 to the focal length f may be selected to cause an image that is produced by the FZPL 412 at the focal plane to fill an entirety of the receiving surface 424.

A numerical aperture N of the FZPL is represented by the following equation:

N=r/f (Equation 3)

The aperture angle θ between an outer edge of a cone 420, which results from the image that is produced by the FZPL 412 being focused on the antenna 406, and an axis 422 that is normal to the receiving surface 424 of the antenna 406 is represented by the following equation:

θ=tan⁻¹(N) (Equation 4)

FIG. 5 is an example intensity profile 500 for an image that is produced at a focal plane by a Fresnel zone plate lens (FZPL) in accordance with an embodiment. The intensity profile 500 illustrates the normalized intensity of the image at the focal plane for a variety of aperture angles θ. As shown in FIG. 5, the intensity of the image is reduced by −3 dB at an aperture angle θ having an absolute value of approximately two degrees. Accordingly, the intensity of the image at the focal plane if the absolute value of the aperture angle θ is approximately two degrees is 50% of the intensity of the image at the focal plane if the aperture angle θ were zero degrees. As further shown in FIG. 5, if the aperture angle θ has an absolute value of three degrees, the intensity of the image at the focal plane is attenuated by −16.7 dB as compared to the intensity of the image at the focal plane if the aperture angle θ were zero degrees.

The intensity profile 500, as depicted in FIG. 5, is based on the attenuated microwave signal that is received at the FZPL having a diameter of 40 cm and the FZPL having a focal length f of 30 cm for non-limiting, illustrative purposes. It will be recognized by persons skilled in the relevant art that the attenuated microwave signal may have any suitable diameter, and the FZPL may have any suitable focal length f.

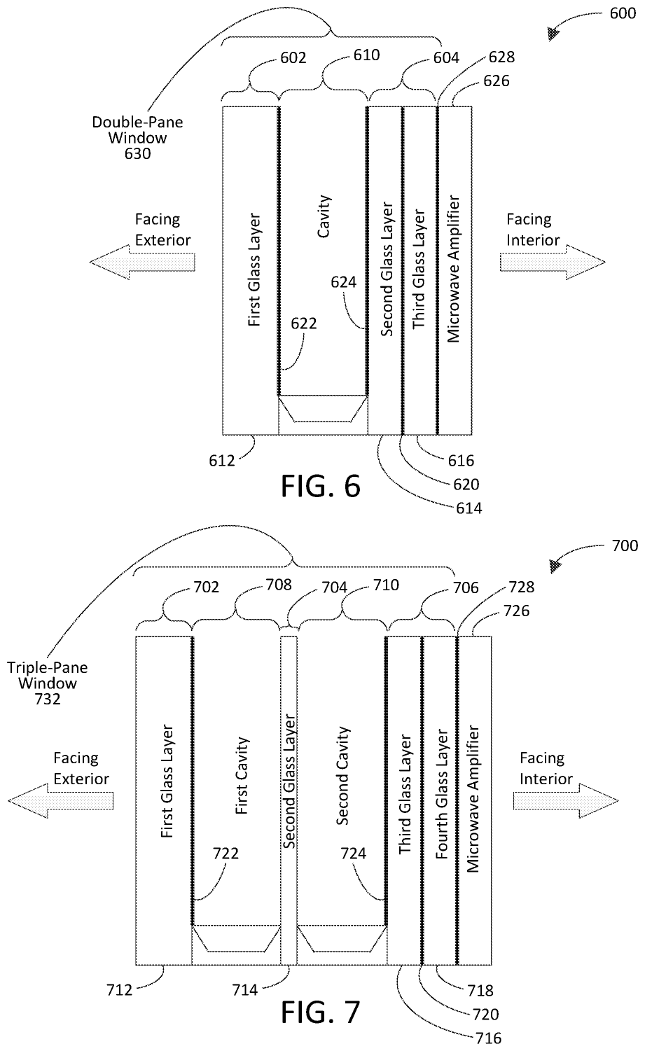

FIG. 6 shows a cross-section of an example system 600 in which a microwave amplifier 626 is adhered to a double-pane window 630 in accordance with an embodiment. The double-pane window 630 includes a first pane 602 and a second pane 604. A cavity 610 is formed between the first pane 602 and the second pane 604. The cavity 610 may be filled with a gas (e.g., an inert gas). The gas may have a relatively low thermal conductivity (e.g., less than 20 milliwatts per meter K (mW/m K) at 300 K) to help increase energy efficiency of the double-pane window 630. For instance, the gas may be Argon, which is known to have a thermal conductivity of 18 mW/m K at 300 K. The cavity 610 may be sealed.

The first pane 602 includes a first glass layer. The first glass layer 612 has first and second opposing surfaces. The second surface of the first glass layer 612 faces the cavity 610. A first low-E coating 622 is on the second surface of the first glass layer 612.

The second pane 604 includes a second glass layer 614 and a third glass layer 616. Each of the second glass layer 614 and the third glass layer 616 has first and second opposing surfaces. The first surface of the second glass layer 614 faces the cavity 610. A second low-E coating 624 is on the first surface of the second glass layer 614. The second surface of the second glass layer 614 and the first surface of the third glass layer 616 are attached using an adhesive 620.

The microwave amplifier 626 is attached to the second surface of the third glass layer 616 using an adhesive 628. Each of the adhesives 620 and 628 may be polyvinyl butyral, for example. The microwave amplifier 626 is shown to be attached to the second surface of the third glass layer 616 in FIG. 6 for illustrative purposes and is not intended to be limiting. It will be recognized that the microwave amplifier 626 may be attached to the first surface of the first glass layer 612 instead, or a first microwave amplifier may be attached to the first pane 602 (e.g., the first surface of the first glass layer 612) and a second microwave amplifier may be attached to the second pane 604 (e.g., the second surface of the third glass layer 616).

The second pane 604 is shown in FIG. 6 to include two glass layers for illustrative purposes and is not intended to be limiting. It will be recognized that the second pane 604 may include a single glass layer. The system 600 need not necessarily include the first low-E coating 622 or the second low-E coating 624.

The first pane 602 is shown in FIG. 6 to face an exterior of an object on which the double-pane window 630 is to be installed, and the second pane 604 is shown to face an interior of the object, for non-limiting, illustrative purposes. Accordingly, the first glass layer 612 may be said to face the exterior of the object. The second glass layer 614 and/or the third glass layer 616 may be said to face the interior of the object. It will be recognized that the first pane 602 may face the interior of the object, and the second pane 604 may face the exterior of the object.

FIG. 7 shows a cross-section of an example system 700 in which a microwave amplifier 726 is adhered to a triple-pane window 732 in accordance with an embodiment. The triple-pane window 732 includes a first pane 702, a second pane 704, and a third pane 706. The second pane 704 is positioned between the first pane 702 and the third pane 706. A first cavity 708 is formed between the first pane 702 and the second pane 704. A second cavity 710 is formed between the second pane 704 and the third pane 706. Each of the first and second cavities 708 and 710 may be filled with a gas and/or sealed.

The first pane 702 includes a first glass layer 712. The second pane 704 includes a second glass layer 714. The third pane 706 includes a third glass layer 716 and a fourth glass layer 718, which are attached using an adhesive 720. Each of the first, second, third, and fourth glass layers 712, 714, 716, and 718 has first and second opposing surfaces. The second surface of the first glass layer 712 and the first surface of the second glass layer 714 face the first cavity 608. The second surface of the second glass layer 714 and the first surface of the third glass layer 716 face the second cavity 710. A first low-E coating 722 is on the second surface of the first glass layer 712, and a second low-E coating 724 is on the first surface of the third glass layer 716, for non-limiting, illustrative purposes. It will be recognized that a low-E coating may be on the first and/or second surface of the second glass layer 714 in addition to or in lieu of the first low-E coating 722 being on the second surface of the first glass layer 712 and/or the second low-E coating 724 being on the first surface of the third glass layer 716. Accordingly, the system 700 need not necessarily include the first low-E coating 722 and/or the second low-E coating 724.

The microwave amplifier 726 is attached to the second surface of the fourth glass layer 718 using an adhesive 728. Each of the adhesives 720 and 728 may be polyvinyl butyral, for example. The microwave amplifier 726 is shown to be attached to the second surface of the fourth glass layer 718 in FIG. 7 for illustrative purposes and is not intended to be limiting. It will be recognized that the microwave amplifier 726 may be attached to the first surface of the first glass layer 712 instead, or a first microwave amplifier may be attached to the first pane 702 (e.g., the first surface of the first glass layer 712) and a second microwave amplifier may be attached to the second pane 704 (e.g., the second surface of the fourth glass layer 718).

The third pane 706 is shown in FIG. 7 to include two glass layers for illustrative purposes and is not intended to be limiting. It will be recognized that the third pane 706 may include a single glass layer. The first pane 702 is shown in FIG. 7 to face an exterior of an object on which the triple-pane window 732 is to be installed, and the third pane 706 is shown to face an interior of the object, for non-limiting, illustrative purposes. Accordingly, the first glass layer 712 may be said to face the exterior of the object. The third glass layer 716 and/or the fourth glass layer 718 may be said to face the interior of the object. It will be recognized that the first pane 702 may face the interior of the object, and the third pane 706 may face the exterior of the object.

It will be recognized that each of the systems 600 and 700 shown in FIGS. 6-7 may not include one or more of the components shown therein. Furthermore, each of the systems 600 and 700 may include components in addition to or in lieu of the components shown therein. For instance, each of the systems 600 and 700 may include one or more additional glass layers, low-E coatings, cavities, gases filling the cavities, adhesives, and so on.

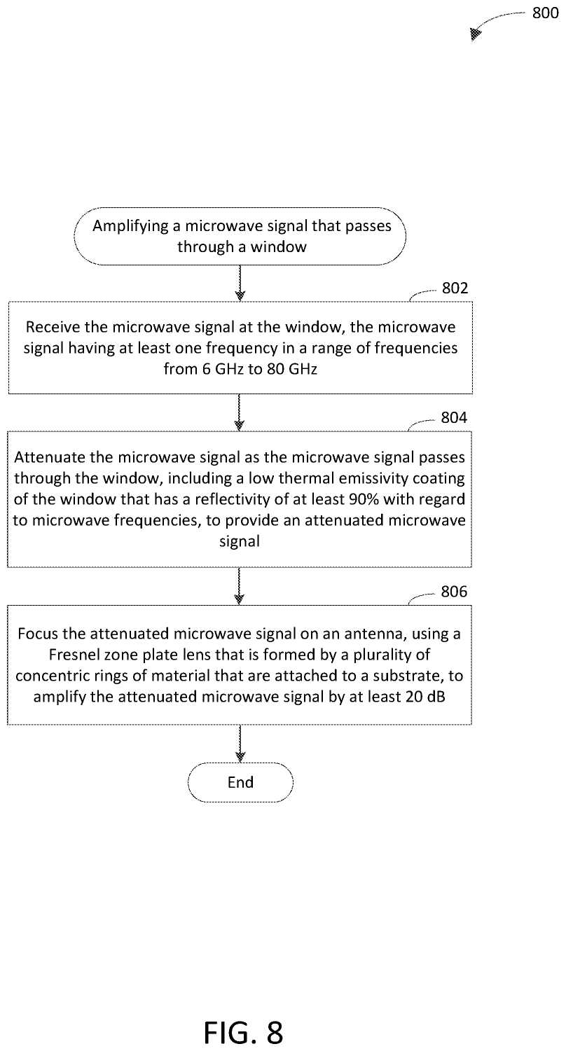

FIG. 8 depicts a flowchart 800 of an example method for amplifying a microwave signal that passes through a window in accordance with an embodiment. Flowchart 800 may be performed by any of systems 100, 600, and 700 shown in respective FIGS. 1, 6 and 7, for example. For illustrative purposes, flowchart 800 will be described with reference to these systems. Further structural and operational embodiments will be apparent to persons skilled in the relevant art(s) based on the discussion regarding the flowchart 800.

As shown in FIG. 8, the method of flowchart 800 begins at step 802. In step 1702, the microwave signal is received at the window. The microwave signal has at least one frequency in a range of frequencies from 6 GHz to 80 GHz. In an example implementation, window 102, double-pane window 630, or triple-pane window 732 receives the microwave signal (e.g., incident microwave signal 114).

At step 804, the microwave signal is attenuated as the microwave signal passes through the window, including a low thermal emissivity coating of the window that has a reflectivity of at least 90% with regard to microwave frequencies, to provide an attenuated microwave signal. In an example implementation, window 102, double-pane window 630, or triple-pane window 732 attenuates the microwave signal as the microwave signal passes through window 102, double-pane window 630, or triple-pane window 732 to provide the attenuated microwave signal (e.g., attenuated microwave signal 116). In accordance with this implementation, any one or more of the low-E coating 108, 622, 624, 722, and/or 724 or a combination (e.g., average) thereof has a reflectivity of at least 90% with regard to microwave frequencies.

At step 806, the attenuated microwave signal is focused on an antenna, using a Fresnel zone plate lens (FZPL) that is formed by a plurality of concentric rings of material and that is attached to a substrate, to amplify the attenuated microwave signal by at least 20 dB. In an example implementation, FZPL 112, which is formed by multiple concentric rings of material and which is attached to a substrate 110, focuses the attenuated microwave signal on an antenna 106 to amplify the attenuated microwave signal by at least 20 dB.

In an example embodiment, focusing the attenuated microwave signal at step 806 includes focusing the attenuated microwave signal on the antenna using the FZPL to provide an image at the antenna. In accordance with this embodiment, an area of the FZPL divided by an area of the image is at least 100. In further accordance with this embodiment, the area of the image may be approximately equal to an area of the antenna.

In another example embodiment, focusing the attenuated microwave signal includes focusing the attenuated microwave signal over a distance between the FZPL and the antenna that corresponds to a focal length of the FZPL. In accordance with this example, the focal length of the FZPL is based on spacings between the concentric rings of the FZPL. In further accordance with this embodiment, the focal length of the FZPL may be in a range from 40 centimeters to 60 centimeters.

In yet another example embodiment, focusing the attenuated microwave signal includes focusing the attenuated microwave signal on the antenna, using the FZPL that has a diameter in a range from 40 centimeters to 80 centimeters, to amplify the attenuated microwave signal by at least 20 dB.

In some example embodiments, one or more steps 802, 804, and/or 806 of flowchart 800 may not be performed. Moreover, steps in addition to or in lieu of steps 802, 804, and/or 806 may be performed.

### III. Further Discussion of Some Example Embodiments

A first example system comprises a window and a microwave amplifier. The window has a low thermal emissivity coating that has a reflectivity of at least 90% with regard to microwave frequencies. The microwave amplifier is positioned proximate the window. The microwave amplifier comprises a substrate and a plurality of concentric rings of a material that form a Fresnel zone plate lens. The Fresnel zone plate lens is configured to focus an attenuated microwave signal, which is attenuated by the low thermal emissivity coating of the window, on an antenna to amplify the attenuated microwave signal by at least 20 dB. The attenuated microwave signal has a designated frequency in a range of frequencies from 6 GHz to 80 GHz. The concentric rings are attached to the substrate.

In a first aspect of the first example system, the material from which the Fresnel zone plate lens is formed is at least one of microwave-reflective or microwave-absorptive.

In a second aspect of the first example system, the material from which the Fresnel zone plate lens is formed is a second low thermal emissivity coating. The second aspect of the first example system may be implemented in combination with the first aspect of the first example system, though the example embodiments are not limited in this respect.

In a third aspect of the first example system, a composition of the low thermal emissivity coating and a composition of the material from which the Fresnel zone plate lens is formed are essentially same. The third aspect of the first example system may be implemented in combination with the first and/or second aspect of the first example system, though the example embodiments are not limited in this respect.

In a fourth aspect of the first example system, the material from which the Fresnel zone plate lens is formed is a polymer. The fourth aspect of the first example system may be implemented in combination with the first, second, and/or third aspect of the first example system, though the example embodiments are not limited in this respect.

In a fifth aspect of the first example system, the low thermal emissivity coating is configured to attenuate a microwave signal by at least 20 dB to provide the attenuated microwave signal. In accordance with the fifth aspect, the Fresnel zone plate lens is configured to compensate for the low thermal emissivity coating attenuating the microwave signal by at least 20 dB by focusing the attenuated microwave signal on the antenna to amplify the attenuated microwave signal by at least 20 dB. The fifth aspect of the first example system may be implemented in combination with the first, second, third, and/or fourth aspect of the first example system, though the example embodiments are not limited in this respect.

In a sixth aspect of the first example system, the Fresnel zone plate lens is configured to focus the attenuated microwave signal on the antenna to amplify the attenuated microwave signal by at least 30 dB. The sixth aspect of the first example system may be implemented in combination with the first, second, third, fourth, and/or fifth aspect of the first example system, though the example embodiments are not limited in this respect.

In a seventh aspect of the first example system, the Fresnel zone plate lens is configured to focus the attenuated microwave signal on the antenna to amplify the attenuated microwave signal by at least 40 dB. The seventh aspect of the first example system may be implemented in combination with the first, second, third, fourth, fifth, and/or sixth aspect of the first example system, though the example embodiments are not limited in this respect.

In an eighth aspect of the first example system, the low thermal emissivity coating of the window is configured to attenuate a microwave signal to provide the attenuated microwave signal. In accordance with the eighth aspect, an angle of incidence of the microwave signal at a designated surface of the window is greater than zero. In further accordance with the eighth aspect, the microwave amplifier is oriented such that an angle between the designated surface and a specified surface of the substrate is approximately equal to the angle of incidence of the microwave signal at the designated surface. The eighth aspect of the first example system may be implemented in combination with the first, second, third, fourth, fifth, sixth, and/or seventh aspect of the first example system, though the example embodiments are not limited in this respect.

In a ninth aspect of the first example system, the designated frequency is in a range of frequencies from 28 GHz to 80 GHz. The ninth aspect of the first example system may be implemented in combination with the first, second, third, fourth, fifth, sixth, seventh, and/or eighth aspect of the first example system, though the example embodiments are not limited in this respect.

In a tenth aspect of the first example system, the designated frequency is 28 GHz, 37 GHz, 39 GHz, or 60 GHz. The tenth aspect of the first example system may be implemented in combination with the first, second, third, fourth, fifth, sixth, seventh, eighth, and/or ninth aspect of the first example system, though the example embodiments are not limited in this respect.

In an eleventh aspect of the first example system, at least one of a width or a height of the window and a diameter of the Fresnel zone plate lens are approximately same. The eleventh aspect of the first example system may be implemented in combination with the first, second, third, fourth, fifth, sixth, seventh, eighth, ninth, and/or tenth aspect of the first example system, though the example embodiments are not limited in this respect.

In a twelfth aspect of the first example system, the substrate has a thickness that is less than or equal to one millimeter. The twelfth aspect of the first example system may be implemented in combination with the first, second, third, fourth, fifth, sixth, seventh, eighth, ninth, tenth, and/or eleventh aspect of the first example system, though the example embodiments are not limited in this respect.

In a thirteenth aspect of the first example system, the substrate has a dielectric loss tangent of less than 0.01. The thirteenth aspect of the first example system may be implemented in combination with the first, second, third, fourth, fifth, sixth, seventh, eighth, ninth, tenth, eleventh, and/or twelfth aspect of the first example system, though the example embodiments are not limited in this respect.

In a fourteenth aspect of the first example system, the substrate has a dielectric loss tangent of less than 0.006. The fourteenth aspect of the first example system may be implemented in combination with the first, second, third, fourth, fifth, sixth, seventh, eighth, ninth, tenth, eleventh, twelfth, and/or thirteenth aspect of the first example system, though the example embodiments are not limited in this respect.

In a fifteenth aspect of the first example system, the microwave amplifier has a dielectric loss tangent of less than 0.001 at the designated frequency. The fifteenth aspect of the first example system may be implemented in combination with the first, second, third, fourth, fifth, sixth, seventh, eighth, ninth, tenth, eleventh, twelfth, thirteenth, and/or fourteenth aspect of the first example system, though the example embodiments are not limited in this respect.

In a sixteenth aspect of the first example system, the concentric rings of the Fresnel zone plate lens are visually undetectable by a human eye having 20/20 vision at a distance of one meter. The sixteenth aspect of the first example system may be implemented in combination with the first, second, third, fourth, fifth, sixth, seventh, eighth, ninth, tenth, eleventh, twelfth, thirteenth, fourteenth, and/or fifteenth aspect of the first example system, though the example embodiments are not limited in this respect.

In a seventeenth aspect of the first example system, the plurality of concentric rings is formed by screen printing portions of the material that correspond to the respective concentric rings on the substrate. The seventeenth aspect of the first example system may be implemented in combination with the first, second, third, fourth, fifth, sixth, seventh, eighth, ninth, tenth, eleventh, twelfth, thirteenth, fourteenth, fifteenth, and/or sixteenth aspect of the first example system, though the example embodiments are not limited in this respect.

In an eighteenth aspect of the first example system, the material includes a first portion that corresponds to the plurality of concentric rings and a second portion that does not correspond to the plurality of concentric rings. In accordance with the eighteenth aspect, the plurality of concentric rings is formed by covering the substrate with the material and etching the second portion of the material from the substrate. The eighteenth aspect of the first example system may be implemented in combination with the first, second, third, fourth, fifth, sixth, seventh, eighth, ninth, tenth, eleventh, twelfth, thirteenth, fourteenth, fifteenth, and/or sixteenth aspect of the first example system, though the example embodiments are not limited in this respect.

In a nineteenth aspect of the first example system, the plurality of concentric rings is formed by spray coating the material onto the substrate through holes in a mask that correspond to the concentric rings. The nineteenth aspect of the first example system may be implemented in combination with the first, second, third, fourth, fifth, sixth, seventh, eighth, ninth, tenth, eleventh, twelfth, thirteenth, fourteenth, fifteenth, and/or sixteenth aspect of the first example system, though the example embodiments are not limited in this respect.

In a twentieth aspect of the first example system, the microwave amplifier is separated from the window by a spaced distance of at least one centimeter. The twentieth aspect of the first example system may be implemented in combination with the first, second, third, fourth, fifth, sixth, seventh, eighth, ninth, tenth, eleventh, twelfth, thirteenth, fourteenth, fifteenth, and/or sixteenth aspect and/or one of the seventeenth, eighteenth, and nineteenth aspects of the first example system, though the example embodiments are not limited in this respect.

In a twenty-first aspect of the first example system, the microwave amplifier is adhered to a surface of the window. The twenty-first aspect of the first example system may be implemented in combination with the first, second, third, fourth, fifth, sixth, seventh, eighth, ninth, tenth, eleventh, twelfth, thirteenth, fourteenth, fifteenth, and/or sixteenth aspect and/or one of the seventeenth, eighteenth, and nineteenth aspects of the first example system, though the example embodiments are not limited in this respect.

A second example system comprises a window and a microwave amplifier. The window has a low thermal emissivity coating that has a reflectivity of at least 90% with regard to microwave frequencies. The microwave amplifier is positioned proximate the window. The microwave amplifier comprises a substrate and a plurality of concentric rings of a material that form a Fresnel zone plate lens. The concentric rings are attached to the substrate. The Fresnel zone plate lens is configured to focus an attenuated microwave signal, which is attenuated by the low thermal emissivity coating of the window and which has a designated frequency in a range of frequencies from 6 GHz to 80 GHz, on an antenna to provide an image at the antenna such that an area of the Fresnel zone plate lens divided by an area of the image is at least 100 and such that the area of the image is approximately equal to an area of the antenna.

In an example method of amplifying a microwave signal that passes through a window, the microwave signal is received at the window. The microwave signal has at least one frequency in a range of frequencies from 6 GHz to 80 GHz. The microwave signal is attenuated as the microwave signal passes through the window, including a low thermal emissivity coating of the window that has a reflectivity of at least 90% with regard to microwave frequencies, to provide an attenuated microwave signal. The attenuated microwave signal is focused on an antenna, using a Fresnel zone plate lens that is formed by a plurality of concentric rings of material that are attached to a substrate, to amplify the attenuated microwave signal by at least 20 dB.

In a first aspect of the example method, focusing the attenuated microwave signal comprises focusing the attenuated microwave signal on the antenna using the Fresnel zone plate lens to provide an image at the antenna. In accordance with the first aspect, an area of the Fresnel zone plate lens divided by an area of the image is at least 100.

In an implementation of the first aspect of the example method, focusing the attenuated microwave signal comprises focusing the attenuated microwave signal on the antenna using the Fresnel zone plate lens to provide the image at the antenna such that the area of the image is approximately equal to an area of the antenna.

In a second aspect of the example method, focusing the attenuated microwave signal comprises focusing the attenuated microwave signal over a distance between the Fresnel zone plate lens and the antenna that corresponds to a focal length of the Fresnel zone plate lens. In accordance with the second aspect, the focal length of the Fresnel zone plate lens is based on spacings between the concentric rings of the Fresnel zone plate lens. The second aspect of the example method may be implemented in combination with the first aspect of the example method, though the example embodiments are not limited in this respect.

In an implementation of the second aspect of the example method, the focal length of the Fresnel zone plate lens is in a range from 40 centimeters to 60 centimeters.

In a third aspect of the example method, focusing the attenuated microwave signal comprises focusing the attenuated microwave signal on the antenna, using the Fresnel zone plate lens that has a diameter in a range from 40 centimeters to 80 centimeters, to amplify the attenuated microwave signal by at least 20 dB. The third aspect of the example method may be implemented in combination with the first and/or second aspect of the example method, though the example embodiments are not limited in this respect.

### IV. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

1. A system comprising:
a window that has a low thermal emissivity coating that has a reflectivity of at least 90% with regard to microwave frequencies; and
a microwave amplifier positioned proximate the window, the microwave amplifier comprising:
a substrate; and
a plurality of concentric rings of a material that form a Fresnel zone plate lens, the Fresnel zone plate lens configured to focus an attenuated microwave signal, which is attenuated by the low thermal emissivity coating of the window, on an antenna to amplify the attenuated microwave signal by at least 20 dB, the attenuated microwave signal having a designated frequency in a range of frequencies from 6 gigahertz to 80 gigahertz, the plurality of concentric rings attached to the substrate.

2. The system of claim 1, wherein the material from which the Fresnel zone plate lens is formed is at least one of microwave-reflective or microwave-absorptive.

3. The system of claim 1, wherein the material from which the Fresnel zone plate lens is formed is a second low thermal emissivity coating.

4. The system of claim 1, wherein the low thermal emissivity coating is configured to attenuate a microwave signal by at least 20 dB to provide the attenuated microwave signal; and
wherein the Fresnel zone plate lens is configured to compensate for the low thermal emissivity coating attenuating the microwave signal by at least 20 dB by focusing the attenuated microwave signal on the antenna to amplify the attenuated microwave signal by at least 20 dB.

5. The system of claim 1, wherein the low thermal emissivity coating of the window is configured to attenuate a microwave signal to provide the attenuated microwave signal;
wherein an angle of incidence of the microwave signal at a designated surface of the window is greater than zero; and
wherein the microwave amplifier is oriented such that an angle between the designated surface and a specified surface of the substrate is approximately equal to the angle of incidence of the microwave signal at the designated surface.

6. The system of claim 1, wherein the designated frequency is in a range of frequencies from 28 gigahertz to 80 gigahertz.

7. The system of claim 1, wherein the designated frequency is 28 gigahertz, 37 gigahertz, 39 gigahertz, or 60 gigahertz.

8. The system of claim 1, wherein the substrate has a thickness that is less than or equal to one millimeter.

9. The system of claim 1, wherein the substrate has a dielectric loss tangent of less than 0.01.

10. The system of claim 1, wherein the plurality of concentric rings is formed by screen printing portions of the material that correspond to the respective concentric rings on the substrate.

11. The system of claim 1, wherein the material includes a first portion that corresponds to the plurality of concentric rings and a second portion that does not correspond to the plurality of concentric rings; and
wherein the plurality of concentric rings is formed by covering the substrate with the material and etching the second portion of the material from the substrate.

12. The system of claim 1, wherein the plurality of concentric rings is formed by spray coating the material onto the substrate through holes in a mask that correspond to the concentric rings.

13. The system of claim 1, wherein the concentric rings of the Fresnel zone plate lens are visually undetectable by a human eye having 20/20 vision at a distance of one meter.

14. A method of amplifying a microwave signal that passes through a window, the method comprising:
receiving the microwave signal at the window, the microwave signal having at least one frequency in a range of frequencies from 6 gigahertz to 80 gigahertz;
attenuating the microwave signal as the microwave signal passes through the window, including a low thermal emissivity coating of the window that has a reflectivity of at least 90% with regard to microwave frequencies, to provide an attenuated microwave signal; and
focusing the attenuated microwave signal on an antenna, using a Fresnel zone plate lens that is formed by a plurality of concentric rings of material that are attached to a substrate, to amplify the attenuated microwave signal by at least 20 dB.

15. The method of claim 14, wherein focusing the attenuated microwave signal comprises:
focusing the attenuated microwave signal on the antenna using the Fresnel zone plate lens to provide an image at the antenna; and
wherein an area of the Fresnel zone plate lens divided by an area of the image is at least 100.

16. The method of claim 15, wherein focusing the attenuated microwave signal comprises:
focusing the attenuated microwave signal on the antenna using the Fresnel zone plate lens to provide the image at the antenna such that the area of the image is approximately equal to an area of the antenna.

17. The method of claim 14, wherein focusing the attenuated microwave signal comprises:
focusing the attenuated microwave signal over a distance between the Fresnel zone plate lens and the antenna that corresponds to a focal length of the Fresnel zone plate lens; and
wherein the focal length of the Fresnel zone plate lens is based on spacings between the concentric rings of the Fresnel zone plate lens.

18. The method of claim 17, wherein the focal length of the Fresnel zone plate lens is in a range from 40 centimeters to 60 centimeters.

19. The method of claim 14, wherein focusing the attenuated microwave signal comprises:
focusing the attenuated microwave signal on the antenna, using the Fresnel zone plate lens that has a diameter in a range from 40 centimeters to 80 centimeters, to amplify the attenuated microwave signal by at least 20 dB.

20. A system comprising:
a window that has a low thermal emissivity coating that has a reflectivity of at least 90% with regard to microwave frequencies; and
a microwave amplifier positioned proximate the window, the microwave amplifier comprising:
a substrate; and
a plurality of concentric rings of a material that form a Fresnel zone plate lens, the plurality of concentric rings attached to the substrate, the Fresnel zone plate lens configured to focus an attenuated microwave signal, which is attenuated by the low thermal emissivity coating of the window and which has a designated frequency in a range of frequencies from 6 gigahertz to 80 gigahertz, on an antenna to provide an image at the antenna such that an area of the Fresnel zone plate lens divided by an area of the image is at least 100 and such that the area of the image is approximately equal to an area of the antenna.

21-32. (canceled)
